(19) United States
(12) Patent Application Publication
(10) Pub. No.: US 2012/0097319 A1
(43) Pub. Date: Apr. 26, 2012

(54) METHOD OF MANUFACTURING MULTILAYER WIRING SUBSTRATE

(75) Inventor: Shinnosuke Maeda, Nagoya-shi (JP)

(73) Assignee: NGK SPARK PLUG CO., LTD., Nagoya-shi (JP)

(21) Appl. No.: 13/280,619

(22) Filed: Oct. 25, 2011

(30) Foreign Application Priority Data
Oct. 26, 2010 (JP) 2010-240206

(51) Int. Cl. B32B 37/14; B32B 37/02

(52) U.S. Cl. 156/151

(57) ABSTRACT

A method of manufacturing a multilayer wiring substrate of the present invention includes a preparation step of preparing a sheet-like insulation core having a thickness of 100 μm or less; a drilling step of forming through-holes which are open at a front surface and a back surface of the insulation core by subjecting the insulation core to laser drilling; a conductor forming step of forming, through electroless copper plating and subsequent copper electroplating, through-hole conductors which completely fill the corresponding through-holes of the insulation core and a respective conductor layer on each of the front surface and the back surface of the insulation core; and a lamination step of laminating a plurality of resin insulation layers and a plurality of conductor layers alternately in multilayer arrangement on each respective conductor layer on the front surface and the back surface of the insulation core.

### CROSS REFERENCE TO RELATED APPLICATIONS

The present application claims priority from Japanese Patent Application No. 2010-240206, which was filed on Oct. 26, 2010, the disclosure of which is herein incorporated by reference in its entirety.

### BACKGROUND OF THE INVENTION

1. Field of the Invention

The present invention relates to a method of manufacturing a multilayer wiring substrate having a structure in which a plurality of resin insulation layers and a plurality of conductor layers are laminated alternately in multilayer arrangement.

2. Description of Related Art

In association with recent increasing tendency toward higher operation speed and higher functionality of semiconductor integrated circuit devices (IC chips) used as, for example, microprocessors of computers, the number of terminals increases, and the pitch between the terminals tends to become narrower. Generally, a large number of terminals are densely arrayed on the bottom surface of an IC chip and flip-chip-bonded to terminals provided on a motherboard. However, since the terminals of the IC chip differ greatly in pitch from those of the motherboard, difficulty is encountered in bonding the IC chip directly onto the motherboard. Thus, according to an ordinarily employed method, a semiconductor package configured such that the IC chip is mounted on an IC chip mounting wiring substrate is fabricated, and the semiconductor package is mounted on the motherboard.

The IC chip mounting wiring substrate which partially constitutes such a semiconductor package has been put into practice in the form of a multilayer wiring substrate configured such that build-up layers are formed on the front and back surfaces of a substrate core (see, for example, Patent Document 1). The substrate core used in the multilayer wiring substrate is, for example, a resin substrate (e.g., glass epoxy substrate) formed by impregnating reinforcement fiber with a resin. Through utilization of rigidity of the substrate core, resin insulation layers and conductor layers are laminated alternately on the front and back surfaces of the substrate core, thereby forming respective build-up layers. In the multilayer wiring substrate, the substrate core serves as a reinforcement and is formed very thick as compared with the build-up layers. Specifically, the substrate core is formed to have a thickness of, for example, about 400 μm. Also, the substrate core has through-hole conductors penetrating therethrough for electrical communication between the build-up layers formed on the front and back surfaces. The through-hole conductors are formed, through electroless copper plating and copper electroplating according to a conventionally known technique, on wall surfaces of through-holes formed in the substrate core by drilling. A closing material such as epoxy resin is charged into the internal spaces of the through-hole conductors through screen printing.

### RELATED ART DOCUMENTS

### Patent Documents

Patent Document 1 is Japanese Patent Application Laid-open (kokai) No. 2010-153839. Patent Document 2 is Japanese Patent Application Laid-open (kokai) No. 2007-214427.

### BRIEF SUMMARY OF THE INVENTION

In a multilayer wiring substrate described in, for example, Patent Document 1, a wiring pattern of a conductor layer is formed through a subtractive process on the front or back surface of a substrate core. Therefore, unlike the case where a semi-additive process is employed, a fine wiring pattern fails to be formed. In addition, such a multilayer wiring substrate poses a problem in that the number of manufacturing steps increases, since wiring patterns are formed on the front and back surfaces of the substrate core through a step different from that of forming through-hole conductors connected to the wiring patterns.

In recent years, in association with implementation of high operation speeds of semiconductor integrated circuit devices, signal frequencies to be used have become those of a high frequency band. In the case where such a high signal frequency is used, when the length of through-hole conductors penetrating through a substrate core increases, the through-hole conductors serve as sources of high inductance, leading to transmission loss of high-frequency signals and occurrence of circuitry malfunction and thus hindering implementation of high operation speed. In order to solve such a problem, a multilayer wiring substrate having no substrate core is proposed (see, for example, Patent Document 2).

The multilayer wiring substrate disclosed in Patent Document 2 is manufactured through the following procedure. Firstly, there are provided a support substrate made of glass epoxy resin, and two copper foils which are separably bonded with each other. Then, the separable copper foils are fixed via an adhesive resin layer onto the support substrate, and a plurality of resin insulation layers and a plurality of conductor layers are laminated alternately in multilayer arrangement on the separable copper foils, to thereby form a build-up layer. Subsequently, a portion of the build-up layer corresponding to an area outside the product area is cut out of the layer so that the separation interface of the separable copper foils is exposed, followed by separation of the copper foils at the interface. Thus, the build-up layer is separated from the support substrate, to thereby yield a thin multilayer wiring substrate having no substrate core (i.e., a coreless wiring substrate).

As described in Patent Document 1, in the case of a multilayer wiring substrate having a substrate core, build-up layers can be formed on both surfaces of the substrate core. In contrast, in the case of a coreless wiring substrate as described in Patent Document 2, a build-up layer is laminated on only one surface of a support substrate. Therefore, when a coreless wiring substrate is manufactured so that the number of laminated layers thereof is equal to that of laminated layers of a multilayer wiring substrate having a substrate core, the number of layer lamination steps increases, and thus a long period of time is required for completion of the coreless wiring substrate.

The present invention has been conceived in view of the above problems, and an object of the invention is to provide a method of manufacturing a multilayer wiring substrate through simplified production steps.

An exemplary means for solving the above problems is a method of manufacturing a multilayer wiring substrate having a main surface and a back surface opposite the main surface, and having a structure in which a plurality of resin insulation layers and a plurality of conductor layers are laminated alternately in a multilayer arrangement. The manufacturing method includes: a preparation step of preparing a sheet-like insulation core made of an insulating material and having a thickness of 100 μm or less; a drilling step of forming through-holes which are open at a front surface and a back surface of the insulation core by subjecting the insulation core to laser drilling; a conductor forming step of forming, through electroless copper plating and subsequent copper electroplating, interlayer connection conductors which completely fill the through-holes of the insulation core and a respective conductor layer on each of the front surface and the back surface of the insulation core, each respective conductor layer being connected to the interlayer connection conductors; and a lamination step of laminating a plurality of resin insulation layers and a plurality of conductor layers alternately in multilayer arrangement on each respective conductor layer on the front surface and the back surface of the insulation core.

According to the exemplary means, in the present invention, there is provided a thin sheet-like insulation core having a thickness of 100 μm or less, which is smaller than the thickness of a substrate core of a conventional multilayer wiring substrate (i.e., 400 μm or more). Unlike the case of a multilayer wiring substrate in which through-holes are formed in a substrate core through drilling, in the present invention, the insulation core is subjected to laser drilling, to thereby form through-holes which are open at the front and back surfaces of the insulation core. In addition, electroless copper plating and subsequent copper electroplating are performed on the insulation core, to thereby form interlayer connection conductors which completely fill the corresponding through-holes of the insulation core, and to form conductor layers which are provided on the front and back surfaces of the insulation core and are connected to the interlayer connection conductor. In the conventional multilayer wiring substrate, a subtractive process is employed for forming wiring patterns on the front and back surfaces of the substrate core. In contrast, in the present invention, a semi-additive process can be employed for forming wiring patterns. Therefore, highly dense and fine wiring patterns of the conductor layers can be formed on the front and back surfaces of the insulation core. In the conventional multilayer wiring substrate, interlayer connection conductors must be formed in the through-holes of the substrate core through a step different from that of forming wiring patterns on the front and back surfaces of the substrate core. In contrast, in the present invention, the interlayer connection conductors can be formed in the insulation core in parallel with formation of the wiring patterns on the front and back surface of the insulation core, and formation of the interlayer connection conductors and the wiring patterns can be carried out through the same step. Therefore, production steps can be simplified.

In the drilling step, laser drilling may be performed on both the front and back surfaces of the insulation core. Specifically, one of two adjacent through-holes is formed from the front surface of the insulation core through laser drilling, and the other through-hole is formed from the back surface of the insulation core through laser drilling. When through-holes are formed from the front surface of the insulation core through laser drilling, the diameter of the through-holes measured at the front surface is greater than that at the back surface. In contrast, when through-holes are formed from the back surface of the insulation core through laser drilling, the diameter of the through-holes measured at the front surface is smaller than that at the back surface. Thus, when a plurality of adjacent through-holes are formed from both the front and back surfaces of the insulation core through laser drilling, the through-holes can be effectively formed at specific intervals.

In the drilling step, each through-hole may be formed through laser drilling from both the front and back surfaces of the insulation core. In this case, there can be formed through-holes whose diameter initially decreases and then increases from the front surface of the insulation core toward the back surface thereof (i.e., through-holes each having a constricted portion). When electroless copper plating and subsequent copper electroplating are performed on the insulation core, a conductor is formed first at the constricted portion of each through-hole of the insulation core, and then the conductor is gradually grown so that each through-hole is completely filled with the interlayer connection conductor without fail.

The multilayer wiring substrate manufactured through the aforementioned method has a main surface and a back surface opposite the main surface, and has a structure in which a plurality of resin insulation layers and a plurality of conductor layers are laminated alternately in multilayer arrangement. The multilayer wiring substrate includes a sheet-like insulation core made of an insulating material and having a thickness of 100 μm or less; first interlayer connection conductors which are provided in corresponding tapered through-holes formed in the insulation core such that the diameter of the through-holes increases from one surface of the core toward the opposite back surface thereof, and which are connected to conductor layers provided on the front and back surfaces of the insulation core; and second interlayer connection conductors which are provided in corresponding tapered through-holes formed in each of a plurality of resin insulation layers laminated on each of the front and back surfaces of the insulation core such that the diameter of the through-holes increases from the inner side (i.e., the side where the insulation core is present) toward the outer side (i.e., the side where the main or back surface of the substrate is present), and which are connected to conductor layers provided on the front and back surfaces of the resin insulation layer.

In the thus-configured multilayer wiring substrate, since the insulation core has a thickness of 100 μm or less, the length of the first interlayer connection conductors is reduced. Therefore, as compared with the case of the multilayer wiring substrate described in Patent Document 1 (i.e., a multilayer wiring substrate having a substrate core), wiring length can be reduced, and transmission loss of high-frequency signals can be lowered.

In the above-configured multilayer wiring substrate, in addition to the second interlayer connection conductors in the plurality of resin insulation layers and the conductor layers on the front and back surfaces of the resin insulation layers, the first interlayer connection conductors in the insulation core and the conductor layers on the front and back surfaces of the insulation core can be formed by a semi-additive process. Therefore, highly dense and fine wiring patterns of the conductor layers can be formed. In addition, since a plurality of resin insulation layers and a plurality of conductor layers can be laminated on both the front and back surfaces of the insulation core, the multilayer wiring substrate can be manufactured within a short period of time.

In the multilayer wiring substrate, the first interlayer connection conductors and the second interlayer connection conductors are formed such that the number of interlayer connection conductors whose diameter increases toward the main surface of the substrate differs from that of interlayer connection conductors whose diameter increases toward the back surface of the substrate. Since the insulation core is thicker than the resin insulation layer, preferably, the first interlayer connection conductors are formed so as to have a diameter greater than that of the second interlayer connection conductors. With this configuration, the conductor layers provided on the front and back surfaces of the insulation core can be reliably connected by means of the first interlayer connection conductors.

A material for a plurality of resin insulation layers partially forming the multilayer wiring substrate can be selected as appropriate in consideration of, for example, electrical insulation performance, heat resistance, and humidity resistance. Examples of preferred polymer materials employed for forming the resin insulation layers include thermosetting resins such as epoxy resin, phenolic resin, urethane resin, silicone resin, and polyimide resin; and thermoplastic resins such as polycarbonate resin, acrylic resin, polyacetal resin, and polypropylene resin.

The insulation core provided in the providing step may be formed from the same material as a plurality of resin insulation layers forming the multilayer wiring substrate. However, preferably, the insulation core is formed of an insulating material containing a reinforcing material (e.g., glass cloth). In this case, the multilayer wiring substrate exhibits increased strength, and warpage of the wiring substrate can be reduced.

### BRIEF DESCRIPTION OF THE DRAWINGS

Illustrative aspects of the invention will be described in detail with reference to the following figures wherein:

FIG. 1 is an enlarged cross-sectional view schematically showing the configuration of a multilayer wiring substrate according to an embodiment of the present invention.

FIG. 2 is an explanatory view for explaining a method of manufacturing the multilayer wiring substrate;

FIG. 3 is an explanatory view for explaining the method of manufacturing the multilayer wiring substrate;

FIG. 4 is an explanatory view for explaining the method of manufacturing the multilayer wiring substrate;

FIG. 5 is an explanatory view for explaining the method of manufacturing the multilayer wiring substrate;

FIG. 6 is an explanatory view for explaining the method of manufacturing the multilayer wiring substrate;

FIG. 7 is an explanatory view for explaining the method of manufacturing the multilayer wiring substrate;

FIG. 8 is an explanatory view for explaining the method of manufacturing the multilayer wiring substrate;

FIG. 9 is an explanatory view for explaining the method of manufacturing the multilayer wiring substrate;

FIG. 10 is an explanatory view for explaining a second method of manufacturing another multilayer wiring substrate;

FIG. 11 is an explanatory view for explaining the second method of manufacturing another multilayer wiring substrate;

FIG. 12 is an explanatory view for explaining a third method of manufacturing another multilayer wiring substrate;

FIG. 13 is an explanatory view for explaining the third method of manufacturing another multilayer wiring substrate;

FIG. 14 is an explanatory view for explaining a fourth method of manufacturing another multilayer wiring substrate; and

FIG. 15 is an explanatory view for explaining the fourth method of manufacturing another multilayer wiring substrate.

### DETAILED DESCRIPTION OF EXEMPLARY EMBODIMENTS OF THE INVENTION

An embodiment of the present invention will next be described in detail with reference to the drawings. FIG. 1 is an enlarged cross-sectional view schematically showing the configuration of a multilayer wiring substrate of the present embodiment.

As shown in FIG. 1, the multilayer wiring substrate 10 according to the present embodiment is an IC chip mounting wiring substrate, and has a main surface 11 (i.e., a surface on which an IC chip is mounted) and a back surface 12 (i.e., a surface opposite the main surface 11) opposite the main surface 11. Specifically, the multilayer wiring substrate 10 includes a sheet-like insulation core 13; a first build-up layer 31 formed on a front surface 14 (upper surface in FIG. 1) of the insulation core 13; and a second build-up layer 32 formed on a back surface 15 (lower surface in FIG. 1) of the insulation core 13.

In the present embodiment, the first build-up layer 31 has a structure in which two resin insulation layers 21 and 22 made of a thermosetting resin (epoxy resin) and conductor layers 26 made of copper are laminated alternately. Similar to the case of the first build-up layer 31, the second build-up layer 32 has a structure in which two resin insulation layers 23 and 24 made of a thermosetting resin (epoxy resin) and conductor layers 26 made of copper are laminated alternately. Each of the resin insulation layers 21 to 24 forming the build-up layers 31 and 32 has a thickness of, for example, about 35 μm, and each of the conductor layers 26 has a thickness of, for example, about 15 μm.

In the multilayer wiring substrate 10, a plurality of IC-chip connection terminals 41, to which an IC chip is to be connected, are arrayed on one side of the first build-up layer 31 toward the main surface 11. Meanwhile, a plurality of motherboard connection terminals 42 for LGA (land grid array), to which a motherboard is to be connected, are arrayed on one side of the second build-up layer 32 toward the back surface 12. The motherboard connection terminals 42 are greater in area than the IC-chip connection terminals 41 provided on the main surface 11 side.

On the side of the first build-up layer 31 toward the main surface 11, almost the entire surface of the outermost layer (i.e., the resin insulation layer 21) is covered with a solder resist layer 35 such that openings 36 for exposing the IC-chip connection terminals 41 are provided in the solder resist layer 35. The openings 36 are smaller in size than the IC-chip connection terminals 41, and a peripheral portion of the outer surface of each IC-chip connection terminal 41 is buried in the solder resist layer 35. The IC-chip connection terminals 41 are made mainly of a copper layer. Furthermore, the IC-chip connection terminals 41 have a structure in which a plating layer 46 of a material other than copper (specifically, a nickel-gold plating layer) covers only the upper surface of the copper layer serving as a main constituent of the IC-chip connection terminals 41.

On the side of the second build-up layer 32 toward the back surface 12, almost the entire surface of the outermost layer (i.e., the resin insulation layer 24) is covered with a solder resist layer 37 such that openings 38 for exposing the motherboard connection terminals 42 are provided in the solder resist layer 37. The openings 38 are smaller in size than the motherboard connection terminals 42, and a peripheral portion of the outer surface of each motherboard connection terminal 42 is buried in the solder resist layer 37. The motherboard connection terminals 42 are made mainly of a copper layer. Furthermore, the motherboard connection terminals 42 have a structure in which a plating layer 48 of a material other than copper (specifically, a nickel-gold plating layer) covers only the lower surface of the copper layer serving as a main constituent of the motherboard connection terminals 42.

The insulation core 13 is provided as a center layer of the multilayer wiring substrate 10 including the build-up layers 31 and 32 formed of the resin insulation layers 21 to 24 and the conductor layers 26. The insulation core 13 has a thickness of 100 μm or less (specifically, about 80 μm) and is made of, for example, a resin insulation material (glass epoxy material) formed by impregnating glass cloth (i.e., a reinforcing material) with an epoxy resin.

The insulation core 13 has a plurality of through-holes 16 penetrating in a thickness direction, and the through-holes 16 are completely filled with through-hole conductors 17 (first interlayer connection conductors). In the present embodiment, each of the through-holes 16 and the through-hole conductors 17 has a tapered shape such that the diameter thereof increases from the back surface 15 of the core toward the front surface 14 thereof. Copper conductor layers 19 are formed on the front surface 14 and the back surface 15 of the insulation core 13 through patterning, and a portion of the conductor layers 19 is electrically connected to the through-hole conductors 17.

Via holes 33 and filled-via conductors 34 (second interlayer connection conductors) are provided in the resin insulation layers 21 to 24 forming the first build-up layer 31 and the second build-up layer 32. Each of the via holes 33 and via conductors 34 provided in the resin insulation layers 21 and 22 of the first build-up layer 31 has a tapered shape such that the diameter thereof increases from the inner side where the insulation core 13 is present toward the main surface 11 of the substrate. Meanwhile, each of the via conductors 34 provided in the resin insulation layers 23 and 24 of the second build-up layer 32 has a tapered shape such that the diameter thereof increases from the inner side where the insulation core 13 is present toward the back surface 12 of the substrate.

The via conductors 34 formed in the resin insulation layers 21 to 24 and the through-hole conductors 17 formed in the insulation core 13 electrically interconnect the conductor layers 19 and 26, the IC-chip connection terminals 41, and the motherboard connection terminals 42.

In the multilayer wiring substrate 10 according to the present embodiment, the through-hole conductors 17 formed in the insulation core 13 have a diameter of, for example, 100 μm, which is greater than the diameter of the via conductors 34 formed in the resin insulation layers 21 to 24 (e.g., 70 μm). Similar to the case of the via conductors 34 formed in the first build-up layer 31, the through-hole conductors 17 are shaped such that the diameter thereof increases in a direction toward the main surface 11 of the substrate. Contrary to the case of the through-hole conductors 17, the via conductors 34 formed in the second build-up layer 32 are shaped such that the diameter thereof increases in a direction toward the back surface 12 of the substrate. Thus, in the multilayer wiring substrate 10, the number of the interlayer connection conductors (through-hole conductors 17 and via conductors 34) which are shaped such that the diameter thereof increases in a direction toward the main surface 11 of the substrate is greater than that of the interlayer connection conductors (via conductors 34) which are shaped such that the diameter thereof increases in a direction toward the back surface 12 of the substrate.

The multilayer wiring substrate 10 having the aforementioned configuration is fabricated through, for example, the following procedure.

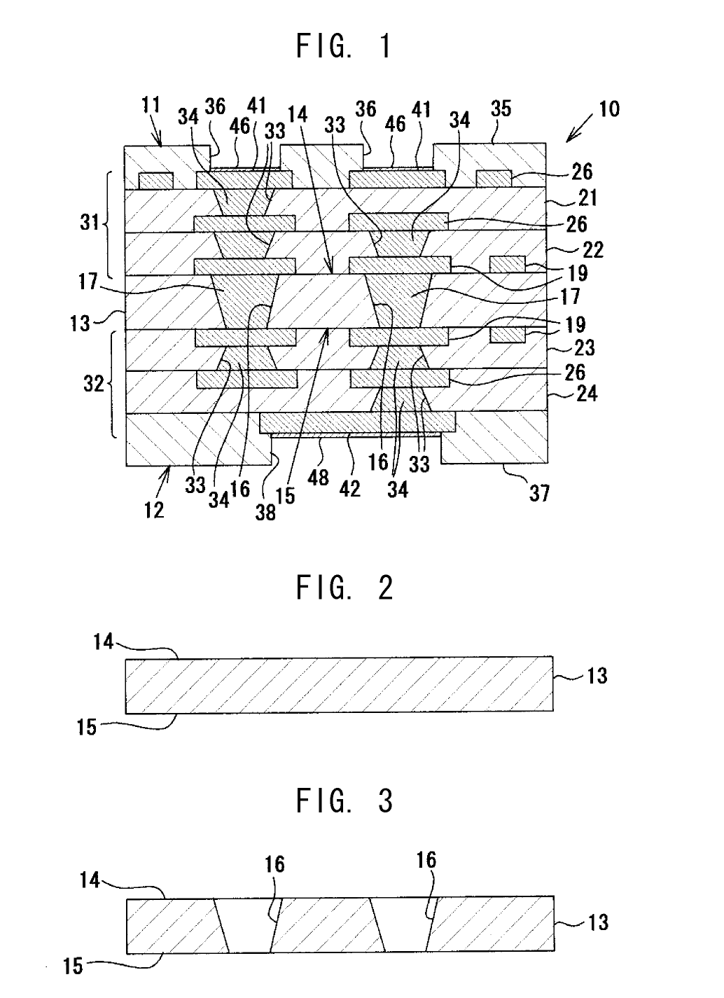

Firstly, as shown in FIG. 2, a sheet-like insulation core 13 having a thickness of 100 μm or less is provided (providing step). Thereafter, as shown in FIG. 3, by means of, for example, an excimer laser, a UV laser, or a CO₂ laser, laser drilling is performed on the insulation core 13 from the front surface 14 (from the upper side in FIG. 3), to thereby form through-holes 16 which are open at both the front surface 14 and the back surface 15 of the insulation core 13 (drilling step).

Subsequently, by use of an etchant such as a potassium permanganate solution, a desmear step is carried out for removing smears from inside the through-holes 16. In the desmear step, in place of treatment by use of an etchant, plasma ashing by means of, for example, O₂ plasma may be performed.

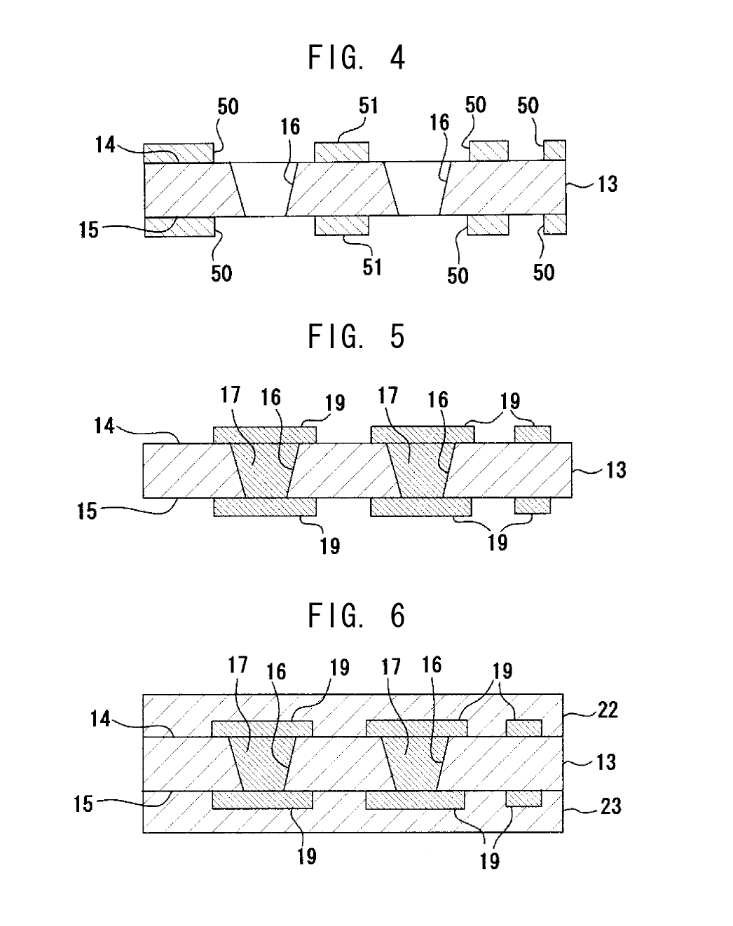

The desmear step is followed by a conductor layer forming step. Specifically, electroless copper plating is carried out for forming an a plating layer (unillustrated) so as to cover the front surface 14 and the back surface 15 of the insulation core 13 and the wall surfaces of the through-holes 16. Then, a dry film for plating resist formation is laminated on the front surface 14 and the back surface 15 of the insulation core 13, and the dry film is subjected to exposure and development. Thus, as shown in FIG. 4, a plating resist layer 51 having a specific pattern in which openings 50 are arranged at positions corresponding to the through-holes 16 and conductor layers 19 is formed on each of the front surface 14 and the back surface 15 of the insulation core.

Thereafter, copper electroplating is selectively carried out on the insulation core having the plating resist layer 51 formed thereon, to thereby form through-hole conductors 17 such that the through-holes 16 are completely filled and to form conductor layers 19 in the openings 50. After removal of the plating resist layer 51 from the front surface 14 and the back surface 15 of the insulation core 13, etching is carried out, to thereby remove the unillustrated plating layer. Thus, as shown in FIG. 5, the through-hole conductors 17 are formed in the insulation core 13, and the conductor layers 19 connected to the through-hole conductors 17 are formed on the front surface 14 and the back surface 15 of the insulation core 13.

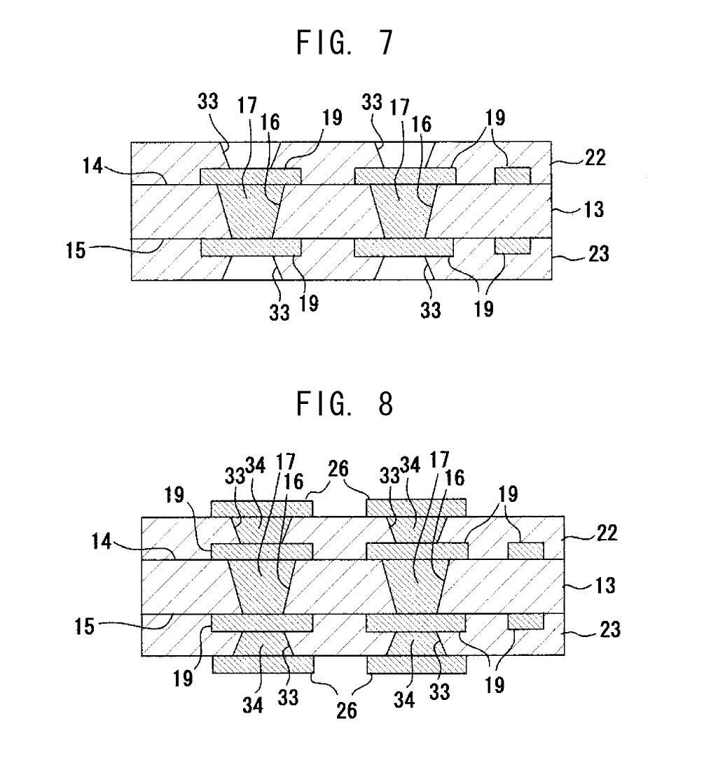

The conductor layer forming step is followed by a layer lamination step of laminating a plurality of resin insulation layers 21 to 24 and a plurality of conductor layers 26 alternately in multilayer arrangement on both the front surface 14 and the back surface 15 of the insulation core 13. Thus, a first build-up layer 31 and a second build-up layer 32 are formed. Specifically, as shown in FIG. 6, a sheet-like resin insulation layer 22 is placed and attached onto the front surface 14 of the insulation core 13, and a sheet-like resin insulation layer 23 is placed and attached onto the back surface 15 of the insulation core 13. Then, as shown in FIG. 7, via holes 33 are formed at specific positions of the resin insulation layers 22 and 23 through laser drilling. Next, by use of an etchant such as a potassium permanganate solution, a desmear step is carried out for removing smears from inside the via holes 33.

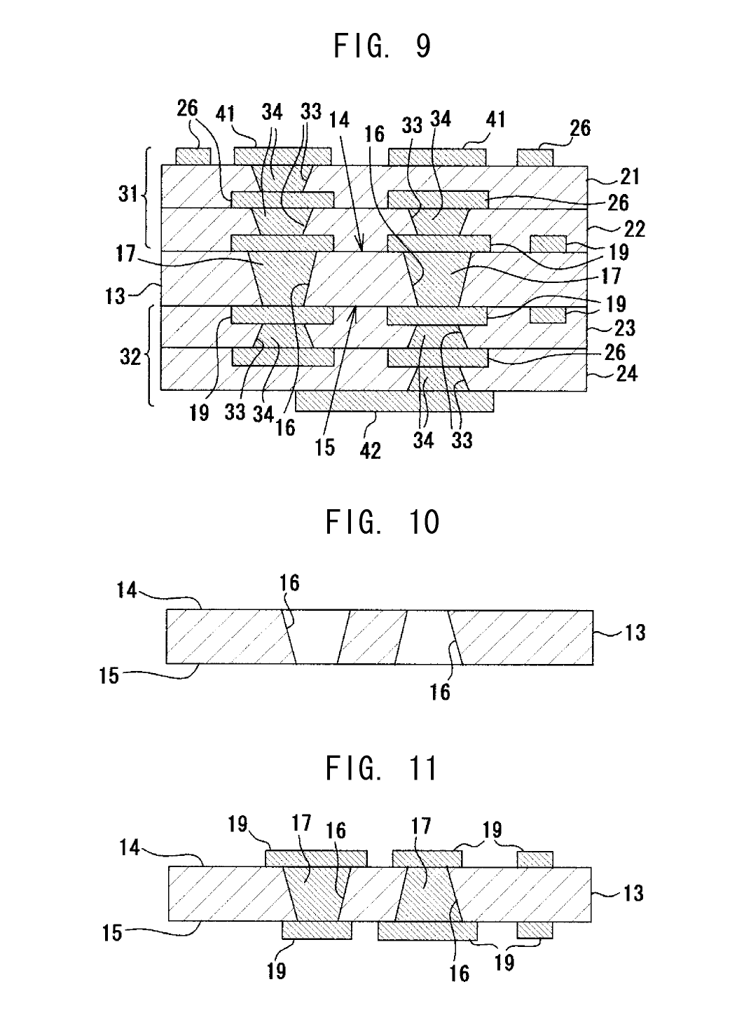

After the desmear step, electroless copper plating and copper electroplating are carried out in a manner similar to that of the aforementioned conductor layer forming step, to thereby form via conductors 34 in the via holes 33 of the resin insulation layers 22 and 23, and to form conductor layers 26 in a specific pattern on the resin insulation layers 22 and 23 (see FIG. 8). Other resin insulation layers 21 and 24 and conductor layers 26 are formed on the resin insulation layers 22 and 23 in a manner similar to that of the aforementioned resin insulation layers 22 and 23 and conductor layers 26. Through this layer lamination step, the first build-up layer 31 is formed on the front surface 14 of the insulation core 13, and the second build-up layer 32 is formed on the back surface 15 of the insulation core 13 (see FIG. 9). IC-chip connection terminals 41 are formed on the surface of the resin insulation layer 21 (i.e., the outermost layer of the first build-up layer 31), and motherboard connection terminals 42 are formed on the surface of the resin insulation layer 24 (i.e., the outermost layer of the second build-up layer 32).

Subsequently, a photosensitive epoxy resin is applied onto the resin insulation layer 21 of the first build-up layer 31, followed by curing of the resin, to thereby form a solder resist layer 35. Thereafter, a specific mask is placed on the solder resist layer 35, and exposure and development are carried out, to thereby form openings 36 in the solder resist layer 35 in a specific pattern. Similarly, a photosensitive epoxy resin is applied onto the resin insulation layer 24 of the second build-up layer 32, followed by curing of the resin, to thereby form a solder resist layer 37. Thereafter, a specific mask is placed on the solder resist layer 37, and exposure and development are carried out, to thereby form openings 38 in the solder resist layer 37 in a specific pattern.

Then, electroless nickel plating and electroless gold plating are sequentially performed on the surfaces (upper surfaces) of the IC-chip connection terminals 41 exposed through the openings 36, and the surfaces (lower surfaces) of the motherboard connection terminals 42 exposed through the openings 38, to thereby form nickel-gold plating layers 46 and 48. Through the above-mentioned steps, the multilayer wiring substrate 10 of FIG. 1 is manufactured.

Therefore, the present embodiment can yield the following effects.

(1) In the present embodiment, there is provided the thin sheet-like insulation core 13 having a thickness of 100 μm or less. Unlike the case of a conventional multilayer wiring substrate in which through-holes are formed through drilling, the insulation core 13 is subjected to laser drilling, to thereby form the through-holes 16 which are open at the front surface 14 and the back surface 15 of the insulation core 13. In addition, electroless copper plating and subsequent copper electroplating are performed on the insulation core 13, to thereby form the through-hole conductors 17 completely filling the through-holes 16 of the insulation core 13, and to form the conductor layers 19 which are provided on the front surface 14 and the back surface 15 of the insulation core 13 and are connected to the through-hole conductors 17. Thus, in the present embodiment, the conductor layers 19 on the front surface 14 and the back surface 15 of the insulation core 13 can be formed through a semi-additive process. Therefore, unlike the case of the conventional wiring substrate wherein a subtractive process is used for forming wiring patterns on the surfaces of the substrate core, highly dense and fine wiring patterns of the conductor layers 19 can be formed on the front surface 14 and the back surface 15 of the insulation core 13. In the case of the conventional wiring substrate, through-hole conductors must be formed in the through-holes of the substrate core through a step different from that of forming wiring patterns on the front and back surfaces of the substrate core. In contrast, in the present embodiment, the through-hole conductors 17 can be formed in the insulation core 13 in parallel with formation of the wiring patterns of the conductor layers 19, and formation of the through-hole conductors 17 and the wiring patterns can be carried out through the same step. Therefore, production steps can be simplified. In addition, since a plurality of resin insulation layers 21 to 24 and a plurality of conductor layers 26 are laminated in multilayer arrangement (i.e., the build-up layers 31 and 32 are formed) on both the front surface 14 and the back surface 15 of the insulation core 13, the multilayer wiring substrate 10 can be manufactured within a short period of time.

(2) In the multilayer wiring substrate 10 according to the present embodiment, since the insulation core 13 has a thickness of 100 μm or less, the length of the through-hole conductors 17 is reduced. Therefore, as compared with the case of the multilayer wiring substrate described in Patent Document 1 (i.e., a multilayer wiring substrate having a substrate core), wiring length can be reduced, and transmission loss of high-frequency signals can be lowered.

(3) In the multilayer wiring substrate 10 according to the present embodiment, the via conductors 34 provided in the resin insulation layers 21 to 24 are formed such that the diameter thereof decreases toward the inner side where the insulation core 13 is present. The through-hole conductors 17 formed in the insulation core 13 has a diameter of 100 μm, which is smaller than the diameter (e.g., 200 μm) of through-hole conductors provided in through-holes formed by drilling in the case of a conventional multilayer wiring substrate. With this configuration, the wiring patterns of the conductor layers 19 and 26 on the inner side where the insulation core 13 is present can be formed at a fine pitch.

(4) In the present embodiment, since the insulation core 13 is formed of an insulating material containing glass cloth (i.e., a reinforcing material), the multilayer wiring substrate 10 exhibits increased strength, and warpage of the wiring substrate 10 can be reduced.

The embodiment of the present invention may be modified as follows.

According to the aforementioned embodiment, in the drilling step, the through-holes 16 are formed through laser drilling from the front surface 14 of the insulation core 13. However, the present invention is not limited thereto, and laser drilling may be performed from both the front surface 14 and the back surface 15 of the insulation core 13. Specifically, as shown in FIG. 10, one of two adjacent through-holes 16 (the left through-hole in FIG. 10) is formed through laser drilling from the front surface 14, and the other through-hole 16 (the right through-hole in FIG. 10) is formed through laser drilling from the back surface 15. In this case, the through-hole 16 formed through laser drilling from the front surface 14 has a tapered shape such that the diameter thereof as measured at the front surface 14 is greater than that as measured at the back surface 15; i.e., the diameter increases toward the front surface 14. In contrast, the through-hole 16 formed through laser drilling from the back surface 15 has a tapered shape such that the diameter thereof as measured at the front surface 14 is smaller than that as measured at the back surface 15; i.e., the diameter increases toward the back surface 15. Therefore, when a plurality of adjacent through-holes 16 are formed from both surfaces of the insulation core 13 through laser drilling, the through-holes 16 can be effectively formed at specific intervals. In the conductor forming step, as shown in FIG. 11, the through-hole conductors 17 are formed in the respective through-holes 16, and the conductor layers 19 connected to the through-hole connectors 17 are formed. With this configuration, the interval between the through-hole conductors 17 can be reduced, and thus the interval between the patterned conductor layers 19 connected thereto can also be reduced.

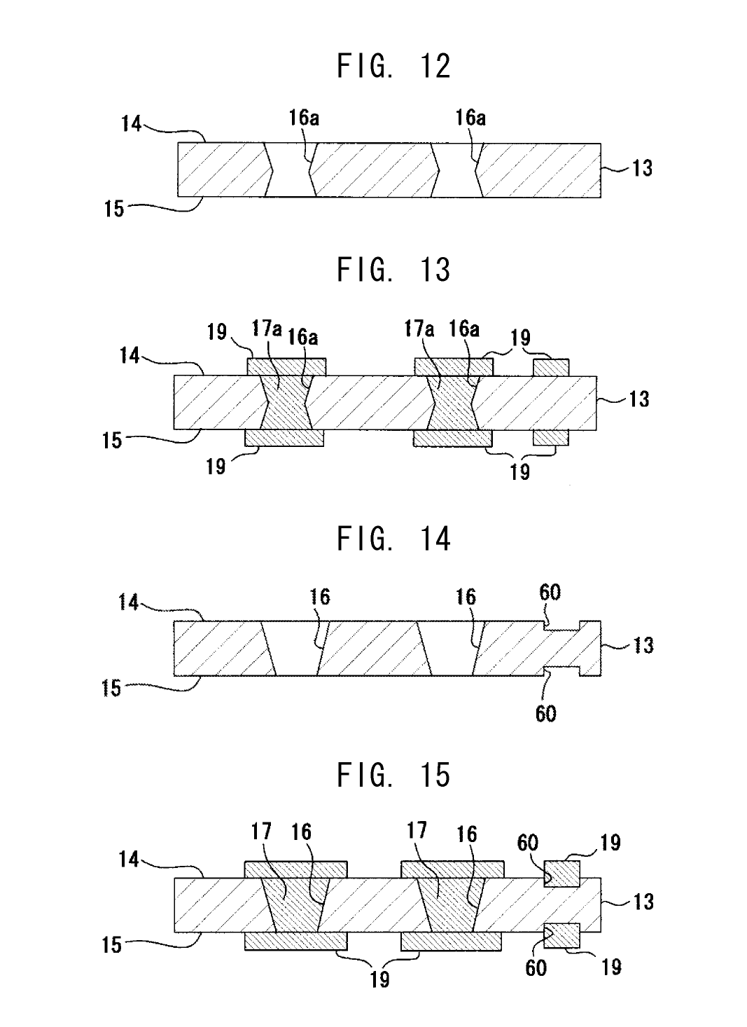

In the drilling step, as shown in FIG. 12, each through-hole 16 may be formed through laser drilling from both the front surface 14 and the back surface 15 of the insulation core 13. In this case, there can be formed through-holes 16a whose diameter initially decreases and then increases from the front surface 14 of the insulation core 13 toward the back surface 15 thereof (i.e., through-holes 16a each having a constricted portion). Subsequently, in the conductor layer forming step, when electroless copper plating and copper electroplating are performed on the insulation core 13, a conductor is formed first at the constricted portion of each through-hole 16a. Thereafter, the conductor is gradually grown so that the through-hole is completely filled with the through-hole conductor 17a without fail (see FIG. 13).

In the aforementioned embodiment, the drilling step is carried out only for forming the through-holes 16. However, the drilling step may be performed for a purpose other than the purpose of forming the through-holes 16. Specifically, in the drilling step, the insulation core 13 is irradiated with a laser beam whose output level is lower than that employed for forming the through-holes 16, to thereby form recesses 60 on the front surface 14 and the back surface 15 of the insulation core 13 at positions at which the wiring patterns of the conductor layers 19 are formed (see FIG. 14). Then, electroless plating and electroplating are performed in a manner similar to that described above, to thereby form the conductor layers 19 so that portions (lower end portions) of the wiring patterns of the conductor layers 19 are buried embedded) in the recesses 60 (see FIG. 15). Thus, since the thickness of the wiring patterns of the conductor layers 19 can be secured sufficiently, electrical characteristics can be improved.

The multilayer wiring substrate 10 according to the aforementioned embodiment is configured such that the number of layers forming the first build-up layer 31 is equal to that of layers forming the second build-up layer 32, and the insulation core 13 is provided as a center layer of the substrate 10. However, the present invention is not limited thereto. For example, the insulation core 13 may be provided at a position displaced from the center layer of the substrate 10 by forming the first and second build-up layers 31 and 32 so that the number of layers of the first build-up layer 31 differs from that of layers of the second build-up layer 32.

In the multilayer wiring substrate 10 according to the aforementioned embodiment, the insulation core 13 is formed of a resin insulating material containing glass cloth, and a plurality of resin insulation layers 21 to 24 are formed of a resin insulating material not containing glass cloth. However, the present invention is not limited thereto. Specifically, the resin insulation layers 21 to 24 may be formed of a resin insulating material containing glass cloth as in the case of the insulation core 13. Alternatively, the insulation core 13 may be formed of a resin insulating material not containing glass cloth as in the case of the resin insulation layers 21 to 24.

Next, technical ideas that the embodiment described above implements are enumerated below.

(1) The method of manufacturing a multilayer wiring substrate described in Means 1 is characterized by the following: the insulation core provided in the providing step is formed from an insulating material containing glass cloth as a reinforcing material.

(2) A multilayer wiring substrate has a main surface and a back surface, and has a structure in which a plurality of resin insulation layers and a plurality of conductor layers are laminated alternately in multilayer arrangement. The multilayer wiring substrate includes a sheet-like insulation core made of an insulating material and having a thickness of 100 μm or less; first interlayer connection conductors which are provided in corresponding tapered through-holes formed in the insulation core such that the diameter of the through-holes increases from one surface of the core toward the opposite back surface thereof, and which are connected to conductor layers provided on the front and back surfaces of the insulation core; and second interlayer connection conductors which are provided in corresponding tapered through-holes formed in each of a plurality of resin insulation layers laminated on each of the front and back surfaces of the insulation core such that the diameter of the through-holes increases from the inner side (i.e., the side where the insulation core is present) toward the outer side (i.e., the side where the main or back surface of the substrate is present), and which are connected to conductor layers provided on the front and back surfaces of the resin insulation layer. The multilayer wiring substrate is characterized by the following: the first interlayer connection conductors and the second interlayer connection conductors are formed such that the number of interlayer connection conductors whose diameter increases toward the main surface of the substrate differs from that of interlayer connection conductors whose diameter increases toward the back surface of the substrate.

(3) The multilayer wiring substrate described above in the technical idea (2) is characterized by the following: the first interlayer connection conductors have a diameter greater than that of the second interlayer connection conductors.

(4) A multilayer wiring substrate has a main surface and a back surface, and has a structure in which a plurality of resin insulation layers and a plurality of conductor layers are laminated alternately in multilayer arrangement. The multilayer wiring substrate is characterized by including a sheet-like insulation core made of an insulating material and having a thickness of 100 μm or less; and interlayer connection conductors which are provided in through-holes formed in the insulation core such that the diameter of the through-holes initially decreases and then increases from one surface of the insulation core toward the back surface opposite thereto (i.e., through-holes each having a constricted portion), and which are connected to conductor layers provided on the front and back surfaces of the insulation core.

### DESCRIPTION OF REFERENCE NUMERALS

10: multilayer wiring substrate
11: main surface of substrate
12: back surface of substrate
13: insulation core
14: front surface of core
15: back surface of core
16, 16a: through-hole
17, 17a: through-hole conductor (interlayer connection conductor)
19: conductor layer
21 to 24: resin insulation layer
26: conductor layer

What is claimed is:

1. A method of manufacturing a multilayer wiring substrate having a main surface and a back surface opposite the main surface, and having a structure in which a plurality of resin insulation layers and a plurality of conductor layers are laminated alternately in a multilayer arrangement, the method comprising:
a preparation step of preparing a sheet-like insulation core made of an insulating material and having a thickness of 100 μm or less;
a drilling step of forming through-holes which are open at a front surface and a back surface of the insulation core by subjecting the insulation core to laser drilling;
a conductor forming step of forming, through electroless copper plating and subsequent copper electroplating, interlayer connection conductors which completely fill the through-holes of the insulation core and a respective conductor layer on each of the front surface and the back surface of the insulation core, each respective conductor layer being connected to the interlayer connection conductors; and
a lamination step of laminating a plurality of resin insulation layers and a plurality of conductor layers alternately in multilayer arrangement on each respective conductor layer on the front surface and the back surface of the insulation core.

2. The method of manufacturing a multilayer wiring substrate according to claim 1, wherein, in the drilling step, laser drilling is performed on both the front surface and the back surface of the insulation core.

3. The method of manufacturing a multilayer wiring substrate according to claim 2, wherein, one of every two adjacent through-holes is formed from the front surface of the insulation core through laser drilling, and the other of every two adjacent through-holes is formed from the back surface of the insulation core through laser drilling.

4. The method of manufacturing a multilayer wiring substrate according to claim 2, wherein, in the drilling step, each through-hole is formed through laser drilling from both the front surface and the back surface of the insulation core.
